(19) United States
(12) Patent Application Publication
(10) Pub. No.: US 2026/0326505 A1
(43) Pub. Date: Oct. 22, 2026

(54) DIAGNOSTIC DEVICE FOR FLOW PATH SWITCHING VALVE

(71) Applicant: TOYOTA JIDOSHA KABUSHIKI KAISHA, Toyota-shi (JP)

(72) Inventors: Masatomo YOSHIHARA, Toyota -shi (JP); Takayuki KAWABE, Toyota-shi (JP); Yusuke NISHIMURA, Kasugai-shi (JP)

(73) Assignee: TOYOTA JIDOSHA KABUSHIKI KAISHA, Toyota-shi (JP)

(21) Appl. No.: 19/529,372

(22) Filed: Feb. 4, 2026

(30) Foreign Application Priority Data
Apr. 3, 2025 (JP) 2025-061846

(51) Int. Cl. B60H 1/00; F16K 37/00

(52) U.S. Cl. CPC B60H 1/00978; F16K 37/005

(57) ABSTRACT

The diagnostic device includes a processing circuit that transmits a switching signal for operating the flow path switching valve to the flow path switching valve. The processing circuit determines that the flow path switching valve is operating normally when the first pre-switching temperature difference is greater than the predetermined value, the second post-switching temperature difference is equal to or less than the predetermined value, and the value obtained by subtracting the lower limit value among the values that the second coolant temperature in the second state can take from the third pre-switching temperature difference is greater than the second post-switching temperature difference.

### CROSS-REFERENCE TO RELATED APPLICATION

This application claims priority to Japanese Patent Application No. 2025-061846 filed on Apr. 3, 2025. The disclosure of the above-identified application, including the specification, drawings, and claims, is incorporated by reference herein in its entirety.

### BACKGROUND

### 1. Technical Field

The present disclosure relates to a diagnostic device for a flow path switching valve.

### 2. Description of Related Art

Japanese Unexamined Patent Application Publication No. 2012-102690 (JP 2012-102690 A) discloses a switching valve failure determination device that determines whether a switching valve is operating normally in a coolant circuit of an engine. The device requests the switching valve to open in order to determine whether the switching valve is operating normally. The device determines that the switching valve is operating normally when a value detected by a coolant temperature sensor upstream of the switching valve after the switching valve is requested to open and a value detected by a coolant temperature sensor downstream of the switching valve are substantially the same. The device determines that a failure has occurred when it cannot be determined that the switching valve is operating normally even after a certain period of time has elapsed.

### SUMMARY

There is also a coolant circuit provided with a flow path switching valve configured to be able to switch a path through which coolant circulates, instead of a switching valve that switches between a state in which the coolant is allowed to flow and a state in which the flow of the coolant is blocked, by opening and closing a path in the coolant circuit. In this case, there may be a case where a value detected by the coolant temperature sensor upstream of the flow path switching valve and a value detected by the coolant temperature sensor downstream of the flow path switching valve are substantially the same, even before the connection state of the flow path on the upstream side and the flow path on the downstream side is switched by the flow path switching valve. In that case, the switching valve failure determination device described above cannot determine whether the flow path switching valve is normal.

In order to address the above issue, there is provided a diagnostic device for a flow path switching valve that is provided in a coolant circuit of a vehicle and switches a path through which coolant circulates by selectively switching a connection state between an upstream flow path and a downstream flow path from among a plurality of connection states. The diagnostic device includes a processing circuit that transmits a switching signal for operating the flow path switching valve to the flow path switching valve. A coolant temperature of the coolant upstream of the flow path switching valve before transmitting the switching signal is defined as a pre-switching upstream coolant temperature. A coolant temperature of the coolant downstream of the flow path switching valve before transmitting the switching signal is defined as a pre-switching downstream coolant temperature. A coolant temperature of the coolant upstream of the flow path switching valve after a lapse of a predetermined time after transmitting the switching signal is defined as a post-switching upstream coolant temperature. A coolant temperature of the coolant downstream of the flow path switching valve after the lapse of the predetermined time after transmitting the switching signal is defined as a post-switching downstream coolant temperature. When transmitting the switching signal for switching the connection state to a predetermined connection state, among the connection states, to the flow path switching valve, the processing circuit determines that the flow path switching valve is operating normally based on both a pre-switching temperature difference and a post-switching temperature difference satisfying respective conditions determined for the pre-switching temperature difference and the post-switching temperature difference, the pre-switching temperature difference being a difference between the pre-switching upstream coolant temperature and the pre-switching downstream coolant temperature, and the post-switching temperature difference being a difference between the post-switching upstream coolant temperature and the post-switching downstream coolant temperature.

The above diagnostic device can determine that the flow path switching valve is operating normally by determining that the flow path switching valve is switched to the predetermined connection state using information on the temperature differences before and after transmitting the switching signal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of a coolant circuit of a vehicle on which a diagnostic device according to a first embodiment is mounted;

FIG. 2 is a flowchart illustrating a flow of a series of processes for diagnosis of a flow path switching valve executed by the processing circuit of FIG. 1;

FIG. 3 is a diagram illustrating conditions determined for the pre-switching temperature difference and the post-switching temperature difference in the diagnostic device according to the first embodiment;

FIG. 4 is a flowchart showing a flow of a series of processes for diagnosing the flow path switching valve executed by the processing circuit of the diagnostic device according to the second embodiment; and

FIG. 5 is a diagram illustrating conditions determined for the pre-switching temperature difference and the post-switching temperature difference in the diagnostic device according to the second embodiment.

### DETAILED DESCRIPTION OF EMBODIMENTS

### First Embodiment

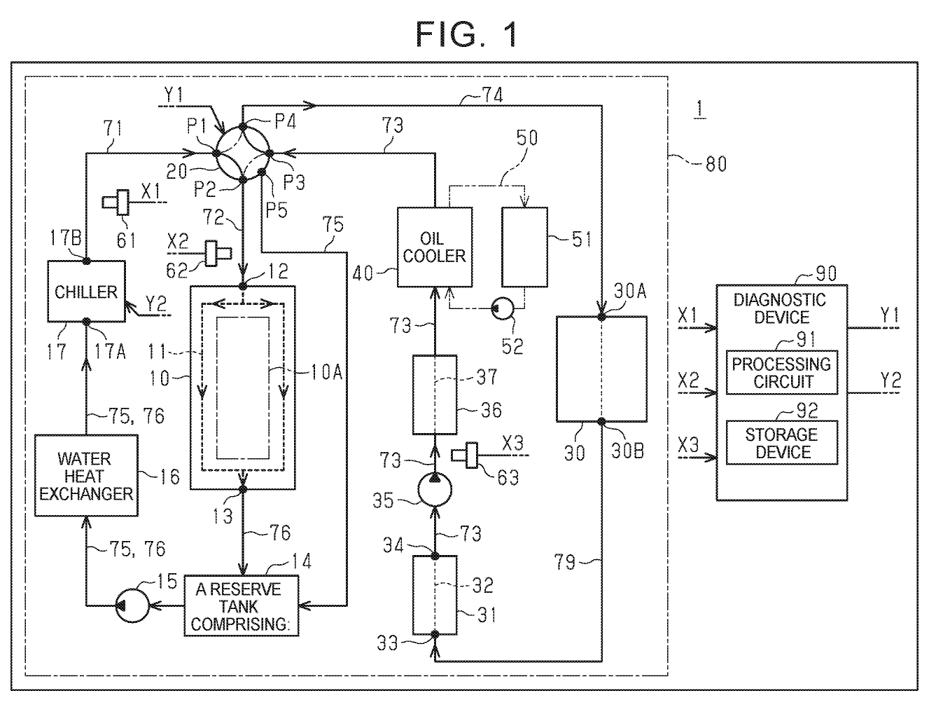

Hereinafter, a diagnostic device according to a first embodiment will be described with reference to FIGS. 1-3.

### Heat management system 1 mounted on a vehicle

As illustrated in FIG. 1, the vehicle includes a battery pack 10 that houses a plurality of battery cells 10A therein, and a drive motor 51 that uses electric power stored in the plurality of battery cells 10A. In FIG. 1, a plurality of battery cells 10A laid in the battery pack 10 are collectively indicated by a dashed-dotted line. The drive motor 51 is a power source of the vehicle. Vehicles are battery electric vehicle (Battery Electric Vehicle: BEV) using only the drive motor 51 as a drive source).

The vehicle is equipped with a heat management system 1. The heat management system 1 is a system for maintaining a plurality of battery cells 10A at an appropriate temperature and cooling a plurality of in-vehicle devices including a drive motor 51. The heat management system 1 includes a coolant circuit 80 and a diagnostic device 90. The flow path switching valve 20 is provided in the coolant circuit 80. The diagnostic device 90 includes a processing circuit 91 that executes a program and executes various processes, and a storage device 92 in which the program is stored. The processing circuit 91 includes a processing circuit. The storage device 92 can store various types of data. Hereinafter, the configuration of the coolant circuit 80 will be described first, and then the diagnosis of the flow path switching valve 20 by the diagnostic device 90 will be described.

### Coolant circuit 80

The coolant circuit 80 is configured to allow coolant to flow therethrough. In FIG. 1, the flow direction of the coolant in the coolant circuit 80 is indicated by an arrow direction. The coolant is, for example, LLC (Long Life Coolant).

As shown in FIG. 1, the coolant circuit 80 includes a first water jacket 11. As indicated by a broken line in FIG. 1, the first water jacket 11 is provided inside the battery pack 10. In the first water jacket 11, heat-exchange is performed between the battery cell 10A accommodated in the battery pack 10 and the coolant.

The coolant circuit 80 includes a chiller 17 that cools the coolant. The chiller 17 is a water-cooled heat exchanger. For example, the chiller 17 exchanges heat between the refrigerant for air conditioning and the coolant flowing through the coolant circuit 80. The refrigerant for air conditioning is, for example, a HFC (Hydrofluorocarbon) refrigerant or a HFO (Hydrofluoroolefin) refrigerant.

The coolant circuit 80 includes a radiator 30 that cools the coolant. The radiator 30 is an air-cooled heat exchanger.

The coolant circuit 80 includes a second water jacket 32. As indicated by a broken line in FIG. 1, the second water jacket 32 is provided inside the in-vehicle charger 31. In the second water jacket 32, heat exchange is performed between the in-vehicle charger 31 and the coolant. The in-vehicle charger 31 is an in-vehicle device that generates heat. The in-vehicle charger 31 is an in-vehicle device that converts AC power supplied from the outside into DC power and charges the DC power to the battery cell 10A.

The coolant circuit 80 includes an oil cooler 40 that performs heat exchange between the lubricating oil that lubricates the drive motor 51 and the coolant. The lubricating oil circulates in the lubricating oil path 50 shown by the two-dot chain line in FIG. 1. The lubricating oil in the lubricating oil path 50 is circulated by the oil pump 52.

The coolant circuit 80 includes a third water jacket 37. As shown by the broken line in FIG. 1, the third water jacket 37 is provided inside the power control unit 36. In the third water jacket 37, heat exchange is performed between the power control unit 36 and the coolant. The power control unit 36 controls the power supplied to the drive motor 51. The power control unit 36 is an in-vehicle device that generates heat.

The coolant circuit 80 includes a chiller flow path 76, a radiator flow path 79, a first flow path 71, a second flow path 72, a third flow path 73, a fourth flow path 74, and a bypass flow path 75.

The chiller flow path 76 is a flow path from the outlet 13 of the first water jacket 11 to the inlet 17A of the chiller 17. The chiller flow path 76 is provided with a reserve tank 14, a water pump 15, and a water heat exchanger 16. The outlet 13 is connected to a reserve tank 14 in which coolant is stored. The reserve tank 14 is connected to a water pump 15 that circulates coolant. The coolant discharged from the water pump 15 passes through the water heat exchanger 16 and then flows into the inlet 17A. The water heat exchanger 16 is a water-cooled heat exchanger. The water heat exchanger 16 performs heat exchange between, for example, a heat medium for air conditioning and the coolant flowing through the coolant circuit 80. The heat medium for air conditioning is, for example, a LLC.

The radiator flow path 79 is a flow path from the outlet 30B of the radiator 30 to the inlet 33 of the second water jacket 32.

The first flow path 71 is a flow path from the outlet 17B of the chiller 17 to the flow path switching valve 20. The second flow path 72 is a flow path from the flow path switching valve 20 to the inlet 12 of the first water jacket 11. The third flow path 73 is a flow path from the outlet 34 of the second water jacket 32 to the flow path switching valve 20. In the third flow path 73, a water pump 35, a third water jacket 37, and an oil cooler 40 are provided in the order of a water pump 35, a third water jacket 37, and an oil cooler 40 from upstream to downstream. The fourth flow path 74 is a flow path from the flow path switching valve 20 to the inlet 30A of the radiator 30. The bypass flow path 75 is a flow path from the flow path switching valve 20 to the inlet 17A of the chiller 17. The bypass flow path 75 is provided with a reserve tank 14, a water pump 15, and a water heat exchanger 16.

The coolant circuit 80 includes a first coolant temperature sensor 61, a second coolant temperature sensor 62, and a third coolant temperature sensor 63. The first coolant temperature sensor 61 measures a first coolant temperature WT1, which is the coolant temperature of the coolant in the first flow path 71. The second coolant temperature sensor 62 measures a second coolant temperature WT2, which is the coolant temperature of the coolant in the second flow path 72. The third coolant temperature sensor 63 measures a third coolant temperature WT3, which is the coolant temperature of the coolant in the third flow path 73. The third coolant temperature sensor 63 measures, as the third coolant temperature WT3, the coolant temperature of the coolant flowing between the water pump 35 and the power control unit 36 in the third flow path 73.

### Flow path switching valve 20

The flow path switching valve 20 includes a first port P1, a second port P2, a third port P3, a fourth port P4, and a fifth port P5. The first port P1 is connected to the first flow path 71. The second port P2 is connected to the second flow path 72. The third port P3 is connected to the third flow path 73. The fourth port P4 is connected to the fourth flow path 74. The fifth port P5 is connected to the bypass flow path 75.

Flow path switching valve 20 includes a flow path upstream of the flow path switching valve 20, the connection state between the flow path downstream of the flow path switching valve 20, a first state, a second state, a third state, selectively switchable to any of the connection state from among the fourth state It is configured. As a result, the flow path switching valve 20 switches a path through which the coolant circulates. The flow path switching valve 20 is driven by, for example, a step motor.

In the first state, the flow path switching valve 20 connects the first port P1 and the second port P2, and blocks the first port P1 and the fourth port P4, and connects the third port P3 and the fourth port P4, and blocks the third port P3 and the second port P2, and blocks the fifth port P5. A connection state indicated by a solid line in the flow path switching valve 20 in FIG. 1 is a first state. In the first state, the path through which the coolant flows is divided into a path circulating through the chiller 17, the first flow path 71, the second flow path 72, the first water jacket 11, and the chiller flow path 76, a fourth flow path 74, a radiator 30, and a path circulating through the third flow path 73.

In the second state, the flow path switching valve 20 shuts off the first port P1 and the second port P2, and connects the first port P1 and the fourth port P4, and shuts off the third port P3 and the fourth port P4, and connects the third port P3 and the second port P2, and blocks the fifth port P5. A connection state indicated by a dashed-dotted line in the flow path switching valve 20 in FIG. 1 is a second state. In the second state, the path through which the coolant flows is only a path that circulates through the chiller 17, the first flow path 71, the fourth flow path 74, the radiator 30, the third flow path 73, the second flow path 72, the first water jacket 11, and the chiller flow path 76.

In the third state, the flow path switching valve 20 shuts off the first port P1 and the second port P2, and connects the first port P1 and the fourth port P4, and shuts off the third port P3 and the fourth port P4, and connects the third port P3 and the fifth port P5, and blocks the second port P2. In the third state, the path through which the coolant flows is only a path that bypasses the first water jacket 11 and circulates through the chiller 17, the first flow path 71, the fourth flow path 74, the radiator 30, the third flow path 73, and the bypass flow path 75.

In the fourth state, the flow path switching valve 20 shuts off the first port P1 and the second port P2, and shuts off the first port P1 and the fourth port P4, and connects the third port P3 and the fourth port P4, and connects the first port P1 and the fifth port P5, and blocks the second port P2. In the fourth state, the path through which the coolant flows is divided into a path that bypasses the first water jacket 11 and circulates through the chiller 17, the first flow path 71, and the bypass flow path 75, a fourth flow path 74, the radiator 30, and a path that circulates through the third flow path 73.

### Diagnostic device 90

The diagnostic device 90 receives the detection signal X1 output from the first coolant temperature sensor 61, the detection signal X2 output from the second coolant temperature sensor 62, and the detection signal X3 output from the third coolant temperature sensor 63. The processing circuit 91 acquires the coolant temperatures in the respective flow paths based on the detection signal X1, the detection signal X2, and the detection signal X3.

The processing circuit 91 controls the chiller 17 by outputting a command signal Y2 to the chiller 17.

The storage device 92 stores a lower limit value LL of values that the second coolant temperature WT2 can take in the second condition. For example, the storage device 92 may store the upper limit value UL among the values that the second coolant temperature WT2 in the first condition can take.

The processing circuit 91 controls the flow path switching valve 20 by outputting a control signal indicating the valve position of the flow path switching valve 20 as a command signal Y1 toward the flow path switching valve 20. When the flow path switching valve 20 is in a normal state, the flow path switching valve 20 selectively switches the connection state so as to be in the connection state instructed by the control signal. For example, the flow path switching valve 20 may not be able to switch the path to the connection state instructed by the control signal even though the control signal is normally received due to wear of the step motor. That is, the flow path switching valve 20 may fail to operate normally even though the control signal is normally received.

### Diagnosis of the flow path switching valve 20

The processing circuit 91 performs a series of processing for determining whether or not the flow path switching valve 20 is operating normally when the flow path switching valve 20 transmits the switching signal C1 for switching the connection state of the coolant circuit 80 to the first state among the plurality of connection states as the command signal Y1. This series of processing is executed by the processing circuit 91 when, for example, a dealer or the like diagnoses whether or not the flow path switching valve 20 is normal. In the following description, the step number of each process is represented by a number with "S" assigned to the head.

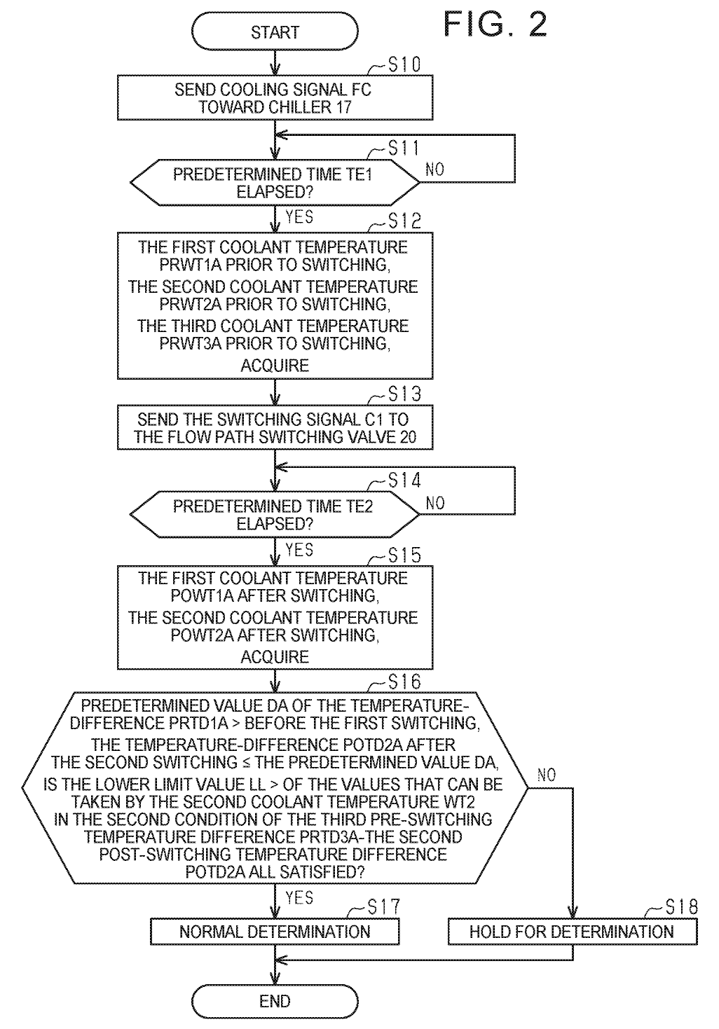

As shown in FIG. 2, when this series of processing is started, in the processing of S10, the processing circuit 91 transmits the cooling signal FC as a command signal Y2 to the chiller 17. The chiller 17 having received the cooling signal FC starts cooling the coolant. Thereafter, the processing circuit 91 advances the processing to S11.

In S11 process, the processing circuit 91 determines whether or not a predetermined time TE1 of times has elapsed. The predetermined time TE1 is determined in advance based on, for example, the cooling capacity of the chiller 17 and the flow path length of the coolant circuit 80. The predetermined time TE1 may be, for example, a time required for the coolant temperature measured by the first coolant temperature sensor 61, the second coolant temperature sensor 62, and the third coolant temperature sensor 63 to stabilize after the chiller 17 is operated in the second condition. The predetermined time TE1 may be determined experimentally in advance. When the predetermined time TE1 has not elapsed (S11: NO), the processing circuit 91 repeatedly executes S11 processing. When the predetermined time TE1 has elapsed (S11: YES), the processing circuit 91 advances the processing to S12.

In S12 process, the processing circuit 91 acquires the pre-switching first coolant temperature PRWT1A, the pre-switching second coolant temperature PRWT2A, and the pre-switching third coolant temperature PRWT3A. The pre-switching first coolant temperature PRWT1A is a first coolant temperature WT1 before the processing circuit 91 transmits the switching signal C1 to the flow path switching valve 20 and when the chiller 17 is in operation. The pre-switching second coolant temperature PRWT2A is a second coolant temperature WT2 before the processing circuit 91 transmits the switching signal C1 to the flow path switching valve 20 and when the chiller 17 is in operation. The pre-switching third coolant temperature PRWT3A is a third coolant temperature WT3 before the processing circuit 91 transmits the switching signal C1 to the flow path switching valve 20 and when the chiller 17 is in operation. The processing circuit 91 acquires the pre-switching first coolant temperature PRWT1A, the pre-switching second coolant temperature PRWT2A, and the pre-switching third coolant temperature PRWT3A, and then advances the processing to S13.

In S13 process, the processing circuit 91 transmits the switching signal C1 toward the flow path switching valve 20. Thereafter, the processing circuit 91 advances the processing to S14.

In S14 process, the processing circuit 91 determines whether or not a predetermined time TE2 of times has elapsed. The predetermined time TE2 is determined in advance based on, for example, the flow path length of the coolant circuit 80. The predetermined time TE2 may be, for example, a time required until the coolant temperature measured by the first coolant temperature sensor 61, the second coolant temperature sensor 62, and the third coolant temperature sensor 63 stabilizes when the connected state is switched from the second state to the first state. The predetermined time TE2 may be determined experimentally in advance. When the predetermined time TE2 has not elapsed (S14: NO), the processing circuit 91 repeatedly executes S14 processing. When the predetermined time TE2 has elapsed (S14: YES), the processing circuit 91 advances the processing to S15.

In S15 process, the processing circuit 91 acquires the switched first coolant temperature POWT1A and the switched second coolant temperature POWT2A. The switched first coolant temperature POWT1A is a first coolant temperature WT1 after a predetermined time TE2 has elapsed. The post-switching second coolant temperature POWT2A is a second coolant temperature WT2 after a predetermined time TE2 has elapsed. The processing circuit 91 acquires the post-switching first coolant temperature POWT1A and the post-switching second coolant temperature POWT2A, and then advances the processing to S16.

In S16 process, the processing circuit 91 calculates the first pre-switching temperature difference PRTD1A, the second post-switching temperature difference POTD2A, and the third pre-switching temperature difference PRTD3A. The first pre-switching temperature difference PRTD1A is a value obtained by subtracting the pre-switching first coolant temperature PRWT1A from the pre-switching second coolant temperature PRWT2A. The second post-switching temperature difference POTD2A is a value obtained by subtracting the post-switching first coolant temperature POWT1A from the post-switching second coolant temperature POWT2A. The third pre-switching temperature difference PRTD3A is a value obtained by subtracting the pre-switching first coolant temperature PRWT1A from the pre-switching third coolant temperature PRWT3A.

In S16 process, the processing circuit 91 determines whether or not the following conditions (A1), conditions (A2), and conditions (A3) are satisfied.

Conditional (A1): The first pre-switching temperature-difference PRTD1A is a value larger than a predetermined value DA. The predetermined value DA is, for example, an upper limit value UL of values that the second coolant temperature WT2 in the first condition can take.

Conditional (A2): The temperature-difference POTD2A after the second switching is less than or equal to the predetermined value DA.

Condition (A3): The value obtained by subtracting the lower limit value LL from the value that the second coolant temperature WT2 in the second state can take from the third pre-switching temperature difference PRTD3A is larger than the second post-switching temperature difference POTD2A.

When the processing circuit 91 determines that all of the conditions (A1), the conditions (A2), and the conditions (A3) are satisfied in S16 processing (S16: YES), the processing proceeds to S17. In S17 process, the processing circuit 91 determines that the connection state of the coolant circuit 80 has been switched to the first state, and determines that the flow path switching valve 20 is performing a normal operation of switching the connection state of the coolant circuit 80 to the first state. Thereafter, the processing circuit 91 ends the series of processing illustrated in FIG. 2.

When the processing circuit 91 determines that at least one of the condition (A1), the condition (A2), and the condition (A3) is not satisfied in S16 processing (S16: NO), the processing proceeds to S18. In S18 process, the processing circuit 91 suspends the determination as to whether or not the flow path switching valve 20 is operating normally. Thereafter, the processing circuit 91 ends the series of processing illustrated in FIG. 2.

When the coolant temperature of the coolant upstream of the flow path switching valve 20 before transmitting the switching signal C1 is set to the pre-switching upstream coolant temperature PRUWT, the pre-switching first coolant temperature PRWT1A is the pre-switching upstream coolant temperature PRUWT. When the coolant temperature of the coolant downstream of the flow path switching valve 20 before transmitting the switching signal C1 is set to the switching front downstream side coolant temperature PRDWT, the switching front second coolant temperature PRWT2A and the switching front third coolant temperature PRWT3A are the switching front downstream side coolant temperature PRDWT.

When the coolant temperature of the coolant upstream of the flow path switching valve 20 after the lapse of the predetermined time TE2 after transmitting the switching signal C1 is set to the upstream coolant temperature POUWT after switching, the first coolant temperature POWT1A after switching is the upstream coolant temperature POUWT after switching. When the coolant temperature of the coolant downstream of the flow path switching valve 20 after the lapse of the predetermined time TE2 after transmitting the switching signal C1 is set as the downstream coolant temperature PODWT after switching, the second coolant temperature POWT2A after switching is the downstream coolant temperature PODWT after switching.

When the difference between the upstream-side coolant temperature PRUWT before switching and the downstream-side coolant temperature PRDWT before switching is set as the pre-switching temperature difference PRTD, the first pre-switching temperature difference PRTD1A and the third pre-switching temperature difference PRTD3A are the pre-switching temperature difference PRTD. When the difference between the post-switching upstream coolant temperature POUWT and the post-switching downstream coolant temperature PODWT is set as the post-switching temperature difference POTD, the second post-switching temperature difference POTD2A is the post-switching temperature difference POTD. That is, in S16 process illustrated in FIG. 2, the processing circuit 91 determines that the flow path switching valve 20 is operating normally based on the fact that both of the pre-switching temperature difference PRTD and the post-switching temperature difference POTD satisfy the respective predetermined conditions.

### Operation of the first embodiment

Among the first state, the second state, the third state, and the fourth state, the connection state in which the coolant cooled by the chiller 17 flows to the first water jacket 11 is the first state and the second state. The path from the chiller 17 to the first water jacket 11 is shorter in the first state than in the second state. Therefore, the battery cell 10A is more likely to be cooled in the first state than in the second state by the coolant cooled by the chiller 17. Therefore, in order to diagnose that the battery cell 10A is in a state of being easily cooled, it is required to determine whether or not the connected state of the flow path switching valve 20 is switched to the first state.

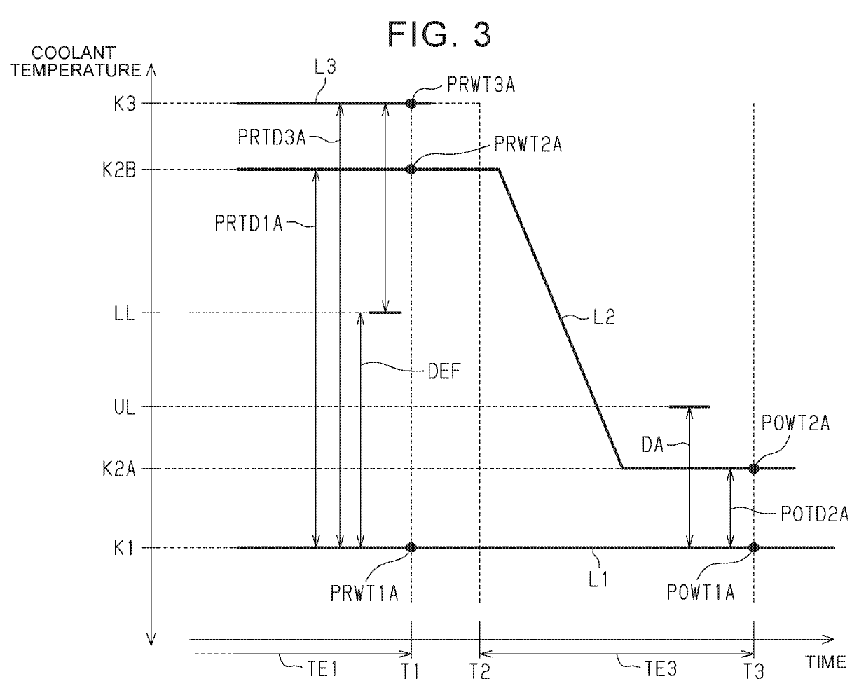

The operation of the first embodiment will be described with reference to FIG. 3. FIG. 3 shows the transition of the first coolant temperature WT1, the second coolant temperature WT2, and the third coolant temperature WT3 when the flow path switching valve 20 is normally switched to the first state in the series of processes shown in FIG. 2. The solid line L1 indicates the transition of the first coolant temperature WT1. The solid line L2 indicates the transition of the second coolant temperature WT2. The solid line L3 indicates the transition of the third coolant temperature WT3. The time "T1" is the time when the predetermined time TE1 elapses after the processing circuit 91 activates the chiller 17. The time "T2" is a time at which the processing circuit 91 transmits the switching signal C1 to the flow path switching valve 20. The time "T3" is the time when the predetermined time TE2 has elapsed from the time "T2".

In S12 process illustrated in FIG. 2, the processing circuit 91 acquires the pre-switching first coolant temperature PRWT1A, the pre-switching second coolant temperature PRWT2A, and the pre-switching third coolant temperature PRWT3A at the time "T1". The pre-switching first coolant temperature PRWT1A at the time "T1" is "K1". The pre-switching second coolant temperature PRWT2A at the time "T1" is "K2B". The pre-switching third coolant temperature PRWT3A at the time "T1" is "K3". In S15 process illustrated in FIG. 2, the processing circuit 91 acquires the post-switching first coolant temperature POWT1A and the post-switching second coolant temperature POWT2A at the time "T3". The first coolant temperature POWT1A after switching at the time "T3" is "K1". The second coolant temperature POWT2A after switching at the time "T3" is "K2A".

Prior to transmitting the switching signal C1 for switching the connection state to the first state, when the first coolant temperature WT1 and the second coolant temperature WT2 is a close value, the connection state of the coolant circuit 80 has become the first state, the first coolant temperature WT1 and the second coolant temperature WT2 cannot be determined to have become a close value. Therefore, the processing circuit 91 uses the fact that the first pre-switching temperature-difference PRTD1A is larger than the predetermined value DA as the first condition (A1) for determining that the coolant circuit 80 has been switched to the first state.

As illustrated in FIG. 3, the first pre-switching temperature-difference PRTD1A at the time "T1" is "K3"–"K1". "K3"–"K1" is greater than the predetermined value DA. Therefore, the transition of the coolant temperature shown in FIG. 3 satisfies the condition (A1).

In the first condition, the coolant flowing out of the chiller 17 passes through the first flow path 71 and then flows into the first port P1 of the flow path switching valve 20. Thereafter, the coolant flowing into the first port P1 flows out of the second port P2 and flows into the second flow path 72. Therefore, in the first condition, the first coolant temperature WT1 and the second coolant temperature WT2 are gradually close to each other. Therefore, the processing circuit 91 uses the fact that the second post-switching temperature difference POTD2A is equal to or less than the predetermined value DA as a second condition (A2) for determining that the connected state is switched to the first state.

As illustrated in FIG. 3, the second post-switching temperature-difference POTD2A at the time "T3" is "K2A"–"K1". "K2A"–"K1" is less than or equal to the predetermined value DA. Therefore, the transition of the coolant temperature shown in FIG. 3 satisfies the condition (A2).

Even when the temperature difference POTD2A after the second switching is equal to or less than the predetermined value DA, when the second coolant temperature POWT2A after the switching is within the range of the values that the second coolant temperature WT2 in the second state can take, there remains a possibility that the connected state after the switching is the second state. When the value obtained by subtracting the lower limit value LL from the value that the second coolant temperature WT2 in the second state can take from the third pre-switching temperature difference PRTD3A is larger than the second post-switching temperature difference POTD2A, the post-switching second coolant temperature POWT2A becomes a temperature lower than the lower limit value LL. Therefore, the processing circuit 91 uses a value obtained by subtracting the lower limit value LL from the third pre-switching temperature difference PRTD3A to be larger than the second post-switching temperature difference POTD2A as a third condition (A3) for determining that the connected state has been switched to the first state.

As shown in FIG. 3, the value DEF obtained by subtracting the lower limit value LL from the value that the second coolant temperature WT2 in the second condition can take from the third pre-switching temperature difference PRTD3A is larger than the second post-switching temperature difference POTD2A. Therefore, the thermal transition shown in FIG. 3 satisfies A3.

### Effect of the first embodiment

(1-1) The diagnostic device 90 can diagnose whether or not the connected state of the path in the coolant circuit 80 can be normally switched to the first state by determining whether or not all of the condition (A1), the condition (A2), and the condition (A3) are satisfied.

(1-2) A second water jacket 32, a third water jacket 37, and an oil cooler 40 are provided in the third flow path 73 of the coolant circuit 80. In the second water jacket 32, heat exchange is performed between the in-vehicle charger 31 and the coolant. In the third water jacket 37, heat exchange is performed between the power control unit 36 and the coolant. In the oil cooler 40, heat exchange is performed between the lubricating oil and the coolant.

In the coolant circuit 80 in which the connected state is in the second state, the coolant cooled by the chiller 17 passes through the second water jacket 32, the third water jacket 37, and the oil cooler 40 before flowing into the first water jacket 11. At this time, the coolant recovers the heat of each in-vehicle device. Therefore, the second coolant temperature WT2 in the second condition tends to be higher than the first coolant temperature WT1. On the other hand, in the first state, coolant at a lower temperature can be caused to flow into the first water jacket 11 than in the second state. The diagnostic device 90 can determine whether or not the flow path switching valve 20 can normally switch the connected state of the coolant circuit 80 to the first state in which the battery cell 10A is easily cooled.

(1-3) When the path through which the coolant circulates is switched by switching the connection state, a change occurs in the temperature difference between the upstream and the downstream of the flow path switching valve 20. The diagnostic device 90 determines whether or not the pre-switching temperature-difference PRTD prior to transmitting the switching signal C1 to be switched to the predetermined connection-state satisfies a predetermined condition. The diagnostic device 90 also determines whether or not the post-switching temperature-difference POTD after the lapse of the predetermined time TE2 after transmitting the switching signal C1 for switching to the predetermined connection-state satisfies the predetermined condition. That is, the diagnostic device 90 determines not only whether or not the temperature difference has decreased, but also whether or not both of the pre-switching temperature difference PRTD and the post-switching temperature difference POTD satisfy the conditions determined respectively, as in the case of simply determining whether or not the path is opened and closed. By performing such determination, it is possible to determine whether or not the path through which the coolant circulates is switched to the predetermined path. According to the diagnostic device 90, it is determined that the flow path switching valve 20 is operating normally by determining that the flow path switching valve is switched to the predetermined connected state by using the temperature-difference data before and after transmitting the switching signal C1.

### Second embodiment

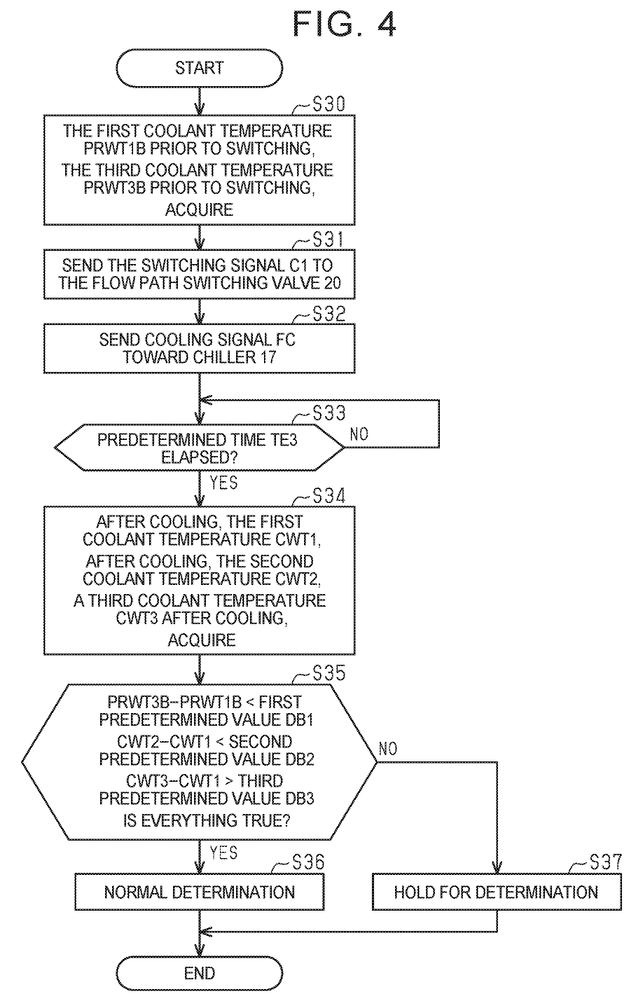

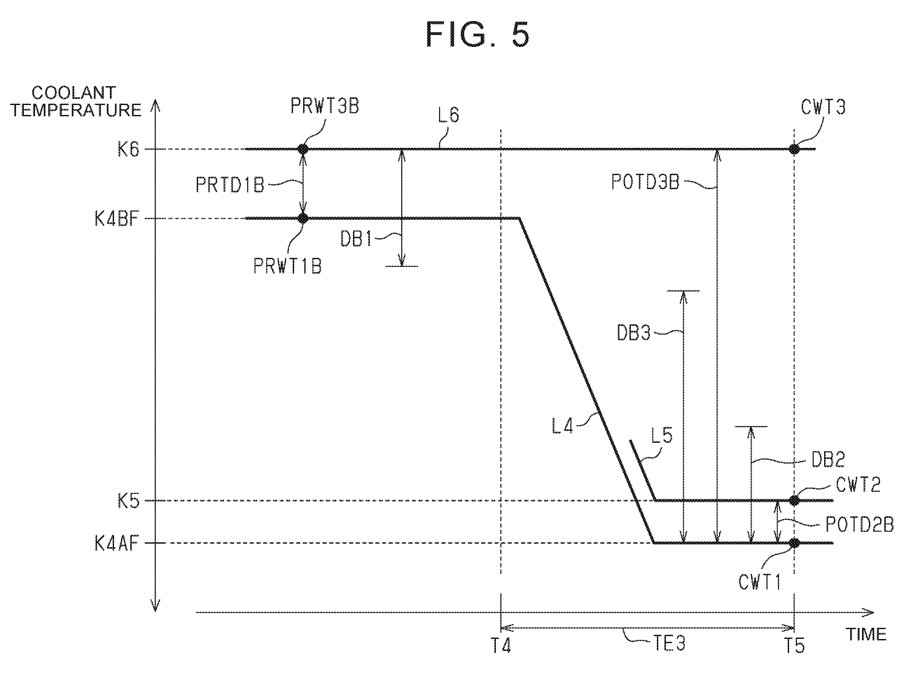

Hereinafter, a diagnostic device for the flow path switching valve 20 according to the second embodiment will be described with reference to FIGS. 4 and 5. The diagnostic device 90 of the present embodiment executes a series of processes illustrated in FIG. 4 instead of the processes illustrated in FIG. 2. This series of processing is executed by the processing circuit 91 when, for example, a dealer or the like diagnoses whether or not the flow path switching valve 20 is normal.

### Diagnosis of the flow path switching valve 20

As shown in FIG. 4, when this series of processes is started, in S30 process, the processing circuit 91 acquires the pre-switching first coolant temperature PRWT1B and the pre-switching third coolant temperature PRWT3B. The pre-switching first coolant temperature PRWT1B is a first coolant temperature WT1 before the processing circuit 91 transmits the switching signal C1 toward the flow path switching valve 20 and when the chiller 17 is not in operation. The pre-switching third coolant temperature PRWT3B is a third coolant temperature WT3 before the processing circuit 91 transmits the switching signal C1 toward the flow path switching valve 20 and when the chiller 17 is not in operation. The processing circuit 91 acquires the pre-switching first coolant temperature PRWT1B and the pre-switching third coolant temperature PRWT3B, and then advances the processing to S31.

In S31 process, the processing circuit 91 transmits the switching signal C1 toward the flow path switching valve 20. Thereafter, the processing circuit 91 advances the processing to S32.

In S32 processing, the processing circuit 91 transmits the cooling signal FC to the chiller 17. The chiller 17 having received the cooling signal FC starts cooling the coolant. Thereafter, the processing circuit 91 advances the processing to S33.

In S33 process, the processing circuit 91 determines whether or not a predetermined time TE3 of times has elapsed since the transmission of the cooling signal FC. The predetermined time TE3 is determined in advance based on, for example, the cooling capacity of the chiller 17 and the flow path length of the coolant circuit 80. The predetermined time TE3 may be, for example, a time taken until the coolant temperature measured by the first coolant temperature sensor 61, the second coolant temperature sensor 62, and the third coolant temperature sensor 63 stabilizes after the chiller 17 is operated in the first condition. The predetermined time TE3 may be determined experimentally in advance. When the predetermined time TE3 has not elapsed (S33: NO), the processing circuit 91 repeatedly executes S33 processing. When the predetermined time TE3 has elapsed (S33: YES), the processing circuit 91 advances the processing to S34.

In S34 process, the processing circuit 91 acquires the first coolant temperature CWT1 after cooling, the second coolant temperature CWT2 after cooling, and the third coolant temperature CWT3 after cooling. The cooled first coolant temperature CWT1 is a first coolant temperature WT1 after a predetermined time TE3 has elapsed. The post-cooling second coolant temperature CWT2 is a second coolant temperature WT2 after a predetermined time TE3 has elapsed. The post-cooling third coolant temperature CWT3 is a third coolant temperature WT3 after a predetermined time TE3 has elapsed. The processing circuit 91 acquires the first coolant temperature CWT1 after cooling, the second coolant temperature CWT2 after cooling, and the third coolant temperature CWT3 after cooling, and then advances the processing to S35.

In S35 process, the processing circuit 91 calculates the first pre-switching temperature difference PRTD1B, the second post-switching temperature difference POTD2B, and the third post-switching temperature difference POTD3B. The first pre-switching temperature difference PRTD1B is a value obtained by subtracting the pre-switching first coolant temperature PRWT1B from the pre-switching third coolant temperature PRWT3B. The second post-switching temperature difference POTD2B is a value obtained by subtracting the post-cooling first coolant temperature CWT1 from the post-cooling second coolant temperature CWT2. The third post-switching temperature difference POTD3B is a value obtained by subtracting the post-cooling first coolant temperature CWT1 from the post-cooling third coolant temperature CWT3.

In S35 process, the processing circuit 91 determines whether or not the following conditions (B1), conditions (B2), and conditions (B3) are satisfied.

Conditional (B1): The first pre-switching temperature-difference PRTD1B is less than the first predetermined value DB1. The first predetermined value DB1 is determined experimentally in advance.

Conditional (B2): The temperature-difference POTD2B after the second switching is less than the second predetermined value DB2. The second predetermined value DB2 is determined experimentally in advance.

Conditional (B3): The temperature-difference PRTD3B after the third switching is larger than the third predetermined value DB3. The third predetermined value DB3 is determined experimentally in advance.

When the processing circuit 91 determines that all of the conditions (B1), the conditions (B2), and the conditions (B3) are satisfied in S35 processing (S35: YES), the processing proceeds to S36. In S36 process, the processing circuit 91 determines that the connected state of the coolant circuit 80 has been switched to the first state, and determines that the flow path switching valve 20 is operating normally, and thereafter, the processing circuit 91 ends the series of processes illustrated in FIG. 4.

When the processing circuit 91 determines that at least one of the condition (B1), the condition (B2), and the condition (B3) is not satisfied in S35 processing (S35: NO), the processing proceeds to S37. In S37 process, the processing circuit 91 suspends the determination as to whether or not the flow path switching valve 20 is operating normally. Thereafter, the processing circuit 91 ends the series of processing illustrated in FIG. 4.

The pre-switching first coolant temperature PRWT1B is the pre-switching upstream coolant temperature PRUWT. The pre-switching third coolant temperature PRWT3B is the pre-switching downstream coolant temperature PRDWT. The first coolant temperature CWT1 after cooling is the upstream coolant temperature POUWT after switching. The post-cooling second coolant temperature CWT2 and the post-cooling third coolant temperature CWT3 are the post-switching downstream-side coolant temperature PODWT. The first pre-switching temperature difference PRTD1B is a pre-switching temperature difference PRTD. The second post-switching temperature difference POTD2B and the third post-switching temperature difference POTD3B are the post-switching temperature difference POTD. That is, in S35 process, the processing circuit 91 determines that the flow path switching valve 20 is operating normally based on the fact that both of the pre-switching temperature difference PRTD and the post-switching temperature difference POTD satisfy the respective predetermined conditions.

### Operation of the second embodiment

The operation of the second embodiment will be described with reference to FIG. 5. FIG. 5 shows the transition of the first coolant temperature WT1, the second coolant temperature WT2, and the third coolant temperature WT3 when the flow path switching valve 20 is normally switched to the first state in the series of processes shown in FIG. 4. The solid line L4 indicates the transition of the first coolant temperature WT1. The solid line L5 indicates the transition of the second coolant temperature WT2. The solid line L6 indicates the transition of the third coolant temperature WT3. The time "T4" is a time at which the processing circuit 91 transmits the cooling signal FC to the chiller 17. The time "T5" is the time when the predetermined time TE3 elapses after the processing circuit 91 transmits the cooling signal FC.

The processing circuit 91 acquires the pre-switching first coolant temperature PRWT1B and the pre-switching third coolant temperature PRWT3B in the processing of S30 illustrated in FIG. 4. The pre-switching first coolant temperature PRWT1B is "K4BF". The pre-switching third coolant temperature PRWT3B is "K6". In the process of S34 illustrated in FIG. 4, the processing circuit 91 acquires the cooled first coolant temperature CWT1, the cooled second coolant temperature CWT2, and the cooled third coolant temperature CWT3 at the time "T5". The cooled first coolant temperature CWT1 at the time "T5" is "K4AF". The cooled second coolant temperature CWT2 at the time "T5" is "K5". The cooled third coolant temperature CWT3 at the time "T5" is "K6".

When there is a difference between the first coolant temperature WT1 and the third coolant temperature WT3 prior to the chiller 17 being operated, it is not possible to determine whether or not the difference between the first coolant temperature WT1 after the chiller 17 is operated and the third coolant temperature WT3 is a difference resulting from the coolant being cooled by the chiller 17. The value obtained by subtracting the pre-switching first coolant temperature PRWT1B from the pre-switching third coolant temperature PRWT3B is the pre-first switching temperature difference PRTD1B. The processing circuit 91 uses the fact that the first pre-switching temperature-difference PRTD1B is less than the predetermined first predetermined value DB1 as the first condition (B1) for determining that the coolant circuit 80 is in the first state.

As shown in FIG. 3, the first pre-switching temperature-difference PRTD1B is "K6"–"K4BF". "K6"–"K4BF" is smaller than the first predetermined value DB1. Therefore, the transition of the coolant temperature shown in FIG. 5 satisfies the condition (B1).

In the second state, the coolant cooled by the chiller 17 passes through the flow path switching valve 20, passes through the fourth flow path 74, the radiator 30, the radiator flow path 79, and the third flow path 73, flows into the flow path switching valve 20 again, and then flows into the second flow path 72. On the other hand, in the first state, the coolant cooled by the chiller 17 does not flow into the fourth flow path 74 but flows only into the second flow path 72 after passing through the flow path switching valve 20. Therefore, the difference between the first coolant temperature WT1 and the second coolant temperature WT2 when the chiller 17 is in operation is smaller in the first state than in the second state. The second coolant temperature CWT2 after cooling minus the first coolant temperature CWT1 after cooling is the temperature differential POTD2B after the second switching. The processing circuit 91 uses the fact that the second post-switching temperature-difference POTD2B is less than the second predetermined value DB2 as a second condition (B2) for determining that the coolant circuit 80 is in the first state.

As illustrated in FIG. 5, the second post-switching temperature-difference POTD2B at the time "T5" is "K5"–"K4AF". "K5"–"K4AF" is less than or equal to the second predetermined value DB2. Therefore, the transition of the coolant temperature shown in FIG. 5 satisfies the condition (B2).

In the first state, the coolant cooled by the chiller 17 does not flow into the third flow path 73. Therefore, in the first condition, the temperature difference between the third coolant temperature WT3 after the chiller 17 is operated and the first coolant temperature WT1 becomes larger than the temperature difference between the third coolant temperature WT3 before the chiller 17 is operated and the first coolant temperature WT1. The post-cooling third coolant temperature CWT3 minus the post-cooling first coolant temperature CWT1 is the post-third switching temperature differential POTD3B. Therefore, as the third condition (B3) for determining that the coolant circuit 80 is in the first state, the processing circuit 91 uses that the third post-switching temperature-difference POTD3B is larger than a predetermined third predetermined value DB3.

As illustrated in FIG. 5, the third post-switching temperature-difference POTD3B at the time "T5" is "K6"–"K4AF". "K6"–"K4AF" is greater than the third predetermined value DB3. Therefore, the thermal transition shown in FIG. 5 satisfies B3.

### Effect of the second embodiment

In the second embodiment, in addition to the effects shown in (1-3) of the first embodiment, the following effects are further exhibited.

(2-1) The diagnostic device 90 can diagnose whether or not the connected state of the flow path in the coolant circuit 80 can be switched to the first state normal by determining whether or not all of the condition (B1), the condition (B2), and the condition (B3) are satisfied.

### Example of change

Elements that can be changed in common in the above-described embodiments include the following. The following modifications may be implemented in combination with each other to the extent that they are not technically inconsistent.

The diagnostic device 90 may be configured to be able to execute both the series of processes illustrated in FIG. 2 and the series of processes illustrated in FIG. 4.

The processing circuit 91 may be configured to perform a series of processing for determining whether or not the flow path switching valve 20 is operating normally while the vehicle is traveling.

For example, when the predetermined time TE1 has elapsed since the cooling signal FC was transmitted to the chiller 17 while the vehicle is traveling, the processing circuit 91 acquires the pre-switching first coolant temperature PRWT1A, the pre-switching second coolant temperature PRWT2A, and the pre-switching third coolant temperature PRWT3A. The processing circuit 91 stores the acquired pre-switching first coolant temperature PRWT1A, pre-switching second coolant temperature PRWT2A, and pre-switching third coolant temperature PRWT3A in the storage device 92. Thereafter, when the process of switching the coolant circuit 80 to the first state is executed in a state where the chiller 17 continues to be operated, the processing circuit 91 acquires the first coolant temperature POWT1A after the switching and the second coolant temperature POWT2A after the switching after the lapse of the predetermined time TE2. The processing circuit 91 calculates the first pre-switching temperature difference PRTD1A and the third pre-switching temperature difference PRTD3A using the pre-switching first coolant temperature PRWT1A, the pre-switching second coolant temperature PRWT2A, and the pre-switching third coolant temperature PRWT3A. The processing circuit 91 calculates the second post-switching temperature difference POTD2A using the post-switching first coolant temperature POWT1A and the post-switching second coolant temperature POWT2A. Then, the processing circuit 91 determines whether the condition (A1), the condition (A2), and the condition (A3) are satisfied.

The processing circuit 91 acquires, for example, the pre-switching first coolant temperature PRWT1B and the pre-switching third coolant temperature PRWT3B while the vehicle is traveling. The processing circuit 91 stores the acquired pre-switching first coolant temperature PRWT1B and pre-switching third coolant temperature PRWT3B in the storage device 92. After that, when the switching signal C1 is transmitted toward the flow path switching valve 20 and then the cooling signal FC is transmitted toward the chiller 17 due to a factor such as the necessity of cooling the battery cell 10A, the following process is performed. That is, after a predetermined time TE3 has elapsed since the cooling signal FC was transmitted, the first coolant temperature CWT1 after cooling, the second coolant temperature CWT2 after cooling, and the third coolant temperature CWT3 after cooling are acquired. The processing circuit 91 determines whether the condition (B1), the condition (B2), and the condition (B3) are satisfied by using the pre-switching first coolant temperature PRWT1B, the pre-switching third coolant temperature PRWT3B, the post-cooling first coolant temperature CWT1, the post-cooling second coolant temperature CWT2, and the post-cooling third coolant temperature CWT3.

The processing circuit 91 may be configured to execute the series of processing illustrated in FIG. 2 and the series of processing illustrated in FIG. 4, for example, when the user of the vehicle selects the diagnosis item of the flow path switching valve 20 displayed on the display of the vehicle.

Vehicles are not limited to battery electric vehicle. It is only necessary that the vehicles have the battery cell 10A accommodated in the battery pack 10. The vehicles may be, for example, plug-in hybrid electric vehicle (Plug-in Hybrid Electric Vehicle: PHEV).

The in-vehicle device provided with the second water jacket 32 is not limited to the in-vehicle charger 31. The in-vehicle device provided with the second water jacket 32 may be any in-vehicle device that generates heat.

The oil cooler 40 and the third water jacket 37 may not be provided in the flow path between the outlet 34 of the second water jacket 32 and the third port P3.

What is claimed is:

1. A diagnostic device for a flow path switching valve that is provided in a coolant circuit of a vehicle and switches a path through which coolant circulates by selectively switching a connection state between an upstream flow path and a downstream flow path from among a plurality of connection states, the diagnostic device comprising
a processing circuit that transmits a switching signal for operating the flow path switching valve to the flow path switching valve, wherein
when a coolant temperature of the coolant upstream of the flow path switching valve before transmitting the switching signal is defined as a pre-switching upstream coolant temperature, a coolant temperature of the coolant downstream of the flow path switching valve before transmitting the switching signal is defined as a pre-switching downstream coolant temperature, a coolant temperature of the coolant upstream of the flow path switching valve after a lapse of a predetermined time after transmitting the switching signal is defined as a post-switching upstream coolant temperature, and a coolant temperature of the coolant downstream of the flow path switching valve after the lapse of the predetermined time after transmitting the switching signal is defined as a post-switching downstream coolant temperature,
the processing circuit is configured to,
when transmitting the switching signal for switching the connection state to a predetermined connection state, among the connection states, to the flow path switching valve,
determine that the flow path switching valve is operating normally based on both a pre-switching temperature difference and a post-switching temperature difference satisfying respective conditions determined for the pre-switching temperature difference and the post-switching temperature difference, the pre-switching temperature difference being a difference between the pre-switching upstream coolant temperature and the pre-switching downstream coolant temperature, and the post-switching temperature difference being a difference between the post-switching upstream coolant temperature and the post-switching downstream coolant temperature.

2. The diagnostic device for a flow path switching valve according to claim 1, wherein:
the coolant circuit includes a first water jacket in which heat exchange is performed between a battery cell accommodated in a battery pack and the coolant, a chiller that cools the coolant, a radiator that cools the coolant, and a second water jacket in which heat exchange is performed between an in-vehicle device that generates heat and the coolant,
a chiller flow path from an outlet of the first water jacket to an inlet of the chiller, a radiator flow path from an outlet of the radiator to an inlet of the second water jacket, a first flow path from an outlet of the chiller to the flow path switching valve, a second flow path from the flow path switching valve to an inlet of the first water jacket, a third flow path from an outlet of the second water jacket to the flow path switching valve, a fourth flow path from the flow path switching valve to an inlet of the radiator, and a bypass flow path from the flow path switching valve to the inlet of the chiller, and
a first coolant temperature sensor that measures a first coolant temperature that is a coolant temperature of the coolant in the first flow path, a second coolant temperature sensor that measures a second coolant temperature that is a coolant temperature of the coolant in the second flow path, and a third coolant temperature sensor that measures a third coolant temperature that is a coolant temperature of the coolant in the third flow path;
the flow path switching valve includes a first port connected to the first flow path, a second port connected to the second flow path, a third port connected to the third flow path, a fourth port connected to the fourth flow path, and a fifth port connected to the bypass flow path;
the flow path switching valve is configured to be able to switch the connection state to
a first state in which the first port and the second port are connected, the first port and the fourth port are disconnected, the third port and the fourth port are connected, the third port and the second port are disconnected, and the fifth port is blocked,
a second state in which the first port and the second port are disconnected, the first port and the fourth port are connected, the third port and the fourth port are disconnected, the third port and the second port are connected, and the fifth port is blocked,
a third state in which the first port and the second port are disconnected, the first port and the fourth port are connected, the third port and the fourth port are disconnected, the third port and the fifth port are connected, and the second port is blocked, and
a fourth state in which the first port and the second port are disconnected, the first port and the fourth port are disconnected, the third port and the fourth port are connected, the third port and the second port are disconnected, and the first port and the fifth port are connected;
the predetermined connection state is the first state;
the processing circuit acquires a pre-switching first coolant temperature, a pre-switching second coolant temperature, and a pre-switching third coolant temperature in a state in which the chiller is operated before transmitting the switching signal for switching to the predetermined connection state to the flow path switching valve, the pre-switching first coolant temperature being the first coolant temperature, the pre-switching second coolant temperature being the second coolant temperature before transmitting the switching signal toward the flow path switching valve, and the pre-switching third coolant temperature being the third coolant temperature before transmitting the switching signal toward the flow path switching valve,
transmits the switching signal for switching to the predetermined connection state toward the flow path switching valve after acquiring the pre-switching first coolant temperature, the pre-switching second coolant temperature, and the pre-switching third coolant temperature, and
acquires a post-switching first coolant temperature and a post-switching second coolant temperature after a predetermined time determined in advance has elapsed after transmitting the switching signal for switching to the predetermined connection state, the post-switching first coolant temperature being the first coolant temperature after a lapse of the predetermined time, and the post-switching second coolant temperature being the second coolant temperature after the lapse of the predetermined time; and
on condition that a first pre-switching temperature difference that is a value obtained by subtracting the pre-switching first coolant temperature from the pre-switching second coolant temperature is a value larger than a predetermined value determined in advance, a second post-switching temperature difference that is a value obtained by subtracting the post-switching first coolant temperature from the post-switching second coolant temperature is the predetermined value or less, and
when a value obtained by subtracting the pre-switching first coolant temperature from the pre-switching third coolant temperature is defined as a third pre-switching temperature difference, a value obtained by subtracting a lower limit value, among values that the second coolant temperature in the second state possibly takes, from the third pre-switching temperature difference is larger than the second post-switching temperature difference,
it is determined that the connection state of the coolant circuit has been switched to the first state, and it is determined that the flow path switching valve is performing a normal operation of switching the connection state of the coolant circuit to the first state.

3. The diagnostic device for a flow path switching valve according to claim 2, wherein the in-vehicle device is an in-vehicle charger that converts AC power supplied from outside into DC power and charges the battery cell, and is applied to the coolant circuit including, in the third flow path, an oil cooler that performs heat exchange between lubricating oil for lubricating a motor that is a power source of the vehicle and the coolant, and a third water jacket that performs heat exchange between a power control unit that controls power of the motor and the coolant.

4. The diagnostic device for a flow path switching valve according to claim 1, wherein:
the coolant circuit includes a first water jacket in which heat exchange is performed between a battery cell accommodated in a battery pack and the coolant, a chiller that cools the coolant, a radiator that cools the coolant, and a second water jacket in which heat exchange is performed between an in-vehicle device that generates heat and the coolant,
a chiller flow path from an outlet of the first water jacket to an inlet of the chiller, a radiator flow path from an outlet of the radiator to an inlet of the second water jacket, a first flow path from an outlet of the chiller to the flow path switching valve, a second flow path from the flow path switching valve to an inlet of the first water jacket, a third flow path from an outlet of the second water jacket to the flow path switching valve, a fourth flow path from the flow path switching valve to an inlet of the radiator, and a bypass flow path from the flow path switching valve to the inlet of the chiller, and
a first coolant temperature sensor that measures a first coolant temperature that is a coolant temperature of the coolant in the first flow path, a second coolant temperature sensor that measures a second coolant temperature that is a coolant temperature of the coolant in the second flow path, and a third coolant temperature sensor that measures a third coolant temperature that is a coolant temperature of the coolant in the third flow path;
the flow path switching valve includes a first port connected to the first flow path, a second port connected to the second flow path, a third port connected to the third flow path, a fourth port connected to the fourth flow path, and a fifth port connected to the bypass flow path;
the flow path switching valve is configured to be able to switch the connection state to
a first state in which the first port and the second port are connected, the first port and the fourth port are disconnected, the third port and the fourth port are connected, the third port and the second port are disconnected, and the fifth port is blocked,
a second state in which the first port and the second port are disconnected, the first port and the fourth port are connected, the third port and the fourth port are disconnected, the third port and the second port are connected, and the fifth port is blocked,
a third state in which the first port and the second port are disconnected, the first port and the fourth port are connected, the third port and the fourth port are disconnected, the third port and the fifth port are connected, and the second port is blocked, and
a fourth state in which the first port and the second port are disconnected, the first port and the fourth port are disconnected, the third port and the fourth port are connected, the third port and the second port are disconnected, and the first port and the fifth port are connected;
the predetermined connection state is the first state;
the processing circuit acquires a pre-switching first coolant temperature and a pre-switching third coolant temperature before transmitting the switching signal for switching to the predetermined connection state to the flow path switching valve, the pre-switching first coolant temperature being the first coolant temperature before transmitting the switching signal toward the flow path switching valve, and the pre-switching third coolant temperature being the third coolant temperature before transmitting the switching signal toward the flow path switching valve,
transmits the switching signal toward the flow path switching valve after acquiring the pre-switching first coolant temperature and the pre-switching third coolant temperature,
transmits a cooling signal for operating the chiller toward the chiller after transmitting the switching signal, and
acquires a post-cooling first coolant temperature, a post-cooling second coolant temperature, and a post-cooling third coolant temperature after a predetermined time determined in advance has elapsed after transmitting the cooling signal, the post-cooling first coolant temperature being the first coolant temperature after a lapse of the predetermined time, the post-cooling second coolant temperature being the second coolant temperature after the lapse of the predetermined time, and the post-cooling third coolant temperature being the third coolant temperature after the lapse of the predetermined time; and
on condition that a first pre-switching temperature difference that is a value obtained by subtracting the pre-switching first coolant temperature from the pre-switching third coolant temperature is less than a first predetermined value determined in advance, a second post-switching temperature difference that is a value obtained by subtracting the post-cooling first coolant temperature from the post-cooling second coolant temperature is less than a second predetermined value determined in advance, and a third post-switching temperature difference that is a value obtained by subtracting the post-cooling first coolant temperature from the post-cooling third coolant temperature is larger than a third predetermined value determined in advance,
it is determined that the connection state of the coolant circuit has been switched to the first state, and it is determined that the flow path switching valve is performing a normal operation of switching the connection state of the coolant circuit to the first state.
